(19) United States
(12) Patent Application Publication
(10) Pub. No.: US 2026/0342028 A1
(43) Pub. Date: Oct. 29, 2026

(54) MAGNETOSTRICTIVE DISPLACEMENT SENSOR COUPLING ADAPTER

(71) Applicant: TEMPOSONICS, LLC, Cary, NC (US)

(72) Inventors: Uwe Viola, Cary, NC (US); Aleksey Minin, Cary, NC (US); Jacob Anthony, Raleigh, NC (US)

(21) Appl. No.: 19/190,259

(22) Filed: Apr. 25, 2025

(51) Int. Cl. H01R 31/06; H01R 13/66

(52) U.S. Cl. CPC H01R 31/065; H01R 13/6683; H01R 13/6691; H01R 2201/20

(57) ABSTRACT

A magnetostrictive displacement sensor coupling adapter includes a sensor detector and a connection circuit. The sensor adapter is configured to generate a sensor mode signal that is indicative of a type of connected sensor electronics. The connection circuit is configured to selectively connect one of a plurality of connection mode circuits to connected signal processing electronics based on the sensor mode signal. Each connection mode circuit is configured to adapt a sensor output signal from the sensor electronics containing a magnetostrictive response signal for processing by the signal processing electronics to estimate a position of a target magnet based on the magnetostrictive response signal.

### FIELD

Embodiments of the present disclosure generally relate to magnetostrictive position measurement systems, and more specifically, to a coupling adapter that facilitates proper signal communications between a sensor electronics and signal processing electronics.

### BACKGROUND

Magnetostrictive position measurement systems or linear position transducers are robust, high resolution instruments which have proven to be useful in many measurement and control applications. Magnetostrictive linear position systems generally include a wire waveguide and a target magnet that has a position that can vary relative to the waveguide. The position of the target magnet along the waveguide is measured based on a magnetostrictive response (e.g., longitudinal or torsional acoustic wave) that is induced in the waveguide in response to an interaction between the magnetic field of the target magnet and a magnetic field of an excitation signal (current pulse) that is conducted through the waveguide.

Magnetostrictive displacement sensors generally include sensor electronics and signal processing electronics. The sensor electronics may include the waveguide, and a pickup having a sensing element, which generates a sensor output signal having an indicator of the magnetostrictive response in the waveguide. The signal processing electronics include an excitation generator circuit, which generates the excitation signal, and a controller, which processes the sensor output signal to estimate the position of the target magnet along the waveguide based on a time-of-flight measurement between the generation of the excitation signal and the indicator in the sensor output signal.

In some magnetostrictive position measurement systems or devices, the sensor electronics may be detachable from the signal processing electronics. This allows for the periodic replacement of the sensor electronics and/or the signal processing electronics and the coupling of the sensor electronics to the signal processing electronics through a cable, for example. The cable connection allows the signal processing electronics to be displaced from a harsh environment (e.g., high temperature) that may be suitable for the sensor electronics but may damage components (e.g., processor) of the signal processing electronics.

Different types of sensor assemblies, such as those having 4, 5 or 6 input/output signal terminals, may require different connections to the input/output signal terminals of the signal processing electronics and may output the sensor output signal in different formats. If the connections between the terminals of the sensor electronics and the signal processing electronics are incorrect, or if the sensor output signal is received in a format that is not compatible with that required by the signal processing electronics, the magnetostrictive position measurement device may be incapable of making a position measurement and/or the signal processing electronics may be damaged, for example.

### SUMMARY

Embodiments of the present disclosure are generally directed to a magnetostrictive displacement sensor coupling adapter that facilitates the formation of magnetostrictive displacement sensors using different types of sensor electronics, a magnetostrictive displacement sensor assembly comprising the coupling adapter and signal processing electronics, and methods of communicating a sensor output signal from sensor electronics using the coupling adapter.

A magnetostrictive displacement sensor coupling adapter is configured to facilitate communication of a sensor output signal from sensor electronics, which includes a waveguide and a target magnet that is moveable relative to the waveguide, to signal processing electronics configured to generate a position estimate of the target magnet relative to the waveguide based on a magnetostrictive response signal contained in the sensor output signal. In one example, the coupling adapter includes a sensor detector configured to generate a sensor mode signal that is indicative of a type of connected sensor electronics, and a connection circuit configured to selectively connect one of a plurality of connection mode circuits to connected signal processing electronics based on the sensor mode signal, each connection mode circuit configured to adapt the sensor output signal for processing by the signal processing electronics.

In some embodiments, the plurality of connection mode circuits includes a first connection mode circuit and a second connection mode circuit, and the sensor mode signal includes a first sensor mode signal that is indicative of a first type of sensor electronics, and a second sensor mode signal that is indicative of a second type of sensor electronics and is distinct from the first sensor mode signal. In response to the first sensor mode signal, the sensor output signal is adapted for processing by the signal processing electronics using the first connection mode circuit. In response to the second sensor mode signal, the sensor output signal is adapted for processing by the signal processing electronics using the second connection mode circuit.

In some embodiments, the signal processing electronics includes a transformer having first and second coils. The first connection mode circuit connects a positive terminal of the first coil to the sensor output signal and a negative terminal of the first coil to a DC voltage in response to the first sensor mode signal. The second connection mode circuit connects the negative terminal of the first coil to the sensor output signal and the positive terminal of the first coil to a DC voltage in response to the second sensor mode signal.

In some embodiments, the first connection mode circuit comprises a capacitor connected between the negative terminal of the first coil and electrical ground, and the second connection mode circuit comprises a capacitor connected between the positive terminal of the first coil and electrical ground.

In some embodiments, the plurality of connection mode circuits includes a third connection mode circuit and the sensor mode signal includes a third sensor mode signal that is indicative of a third type of sensor electronics and is distinct from the first and second sensor mode signals. In response to the third sensor mode signal, the sensor output signal is adapted for processing by the signal processing electronics using the third connection mode circuit.

In some embodiments, the signal processing electronics includes a transformer having first and second coils. The first connection mode circuit connects a positive terminal of the first coil to the sensor output signal and a negative terminal of the first coil to a DC voltage in response to the first sensor mode signal. The second connection mode circuit connects the negative terminal of the first coil to the sensor output signal and the positive terminal of the first coil to a DC voltage in response to the second sensor mode signal The third connection mode circuit connects the positive and negative terminals of the first coil to the sensor output signal in response to the third sensor mode signal.

In some embodiments, the first and second sensor mode signals are based on a voltage of a conductor connected to a waveguide of the sensor electronics or a conductor connected to an excitation generator of the signal processing electronics.

One example of a magnetostrictive displacement sensor assembly includes signal processing electronics configured to generate a position estimate of a target magnet relative to a waveguide of sensor electronics based on a sensor output signal from a pickup of the sensor electronics and a coupling adapter. The coupling adapter includes a sensor detector configured to generate a sensor mode signal that is indicative of a type of the sensor electronics, and a connection circuit configured to selectively connect one of a plurality of connection mode circuits to the signal processing electronics based on the sensor mode signal, each connection mode circuit configured to adapt the sensor output signal for processing by the signal processing electronics.

In some embodiments, a magnetostrictive displacement sensor includes the magnetostrictive displacement sensor assembly, the target magnet and the sensor electronics connected to the coupling adapter, the sensor electronics including the waveguide and the pickup, wherein the pickup is configured to generate the sensor output signal in response to a magnetostrictive response in the waveguide corresponding to the target magnet.

In some embodiments, the magnetostrictive displacement sensor includes a cable connecting the coupling adapter to the sensor electronics.

In some embodiments, the plurality of connection mode circuits includes a first connection mode circuit and a second connection mode circuit. The sensor mode signal includes a first sensor mode signal that is indicative of a first type of sensor electronics, and a second sensor mode signal that is indicative of a second type of sensor electronics and is distinct from the first sensor mode signal. In response to the first sensor mode signal, the sensor output signal is adapted for processing by the signal processing electronics using the first connection mode circuit. In response to the second sensor mode signal, the sensor output signal is adapted for processing by the signal processing electronics using the second connection mode circuit.

In some embodiments, the signal processing electronics includes a transformer having first and second coils. The first connection mode circuit connects a positive terminal of the first coil to the sensor output signal and a negative terminal of the first coil to a DC voltage in response to the first sensor mode signal. The second connection mode circuit connects the negative terminal of the first coil to the sensor output signal and the positive terminal of the first coil to a DC voltage in response to the second sensor mode signal.

In some embodiments, the first connection mode circuit comprises a capacitor connected between the negative terminal of the first coil and electrical ground, and the second connection mode circuit comprises a capacitor connected between the positive terminal of the first coil and electrical ground.

In some embodiments, the plurality of connection mode circuits includes a third connection mode circuit;

the sensor mode signal includes a third sensor mode signal that is indicative of a third type of sensor electronics and is distinct from the first and second sensor mode signals. In response to the third sensor mode signal, the sensor output signal is adapted for processing by the signal processing electronics using the third connection mode circuit.

In some embodiments, the signal processing electronics includes a transformer having first and second coils. The first connection mode circuit connects a positive terminal of the first coil to the sensor output signal and a negative terminal of the first coil to a DC voltage in response to the first sensor mode signal. The second connection mode circuit connects the negative terminal of the first coil to the sensor output signal and the positive terminal of the first coil to a DC voltage in response to the second sensor mode signal. The third connection mode circuit connects the positive and negative terminals of the first coil to the sensor output signal in response to the third sensor mode signal.

In some embodiments, the first and second sensor mode signals are based on a voltage of a conductor connected to the waveguide of the sensor electronics.

In one example of a method of communicating a sensor output signal from sensor electronics, which includes a waveguide and a target magnet that is moveable relative to the waveguide, to signal processing electronics configured to generate a position estimate of the target magnet relative to the waveguide based on a magnetostrictive response signal contained in the sensor output signal, the method includes: providing a coupling adapter between the sensor electronics and the signal processing electronics, the coupling adapter comprising a plurality of connection mode circuits, each configured to adapt the sensor output signal for processing by the signal processing electronics; connecting one of the plurality of connection mode circuits to the signal processing electronics based on a sensor mode signal that is indicative of a type of the sensor electronics; and communicating the sensor output to the signal processing electronics using the connection mode circuit that is connected to the signal processing electronics.

In some embodiments, the plurality of connection mode circuits includes a first connection mode circuit and a second connection mode circuit. Connecting one of the plurality of connection mode circuits to the signal processing electronics comprises: connecting the first connection mode circuit to the signal processing electronics in response to a first sensor mode signal that is indicative of a first type of sensor electronics; and connecting the second connection mode circuit to the signal processing electronics in response to a second sensor mode signal that is indicative of a second type of sensor electronics and is distinct from the first sensor mode signal.

In some embodiments, the signal processing electronics includes a transformer having first and second coils. Connecting the first connection mode circuit to the signal processing electronics comprises connecting a positive terminal of the first coil to the sensor output signal and a negative terminal of the first coil to a DC voltage. Connecting the second connection mode circuit to the signal processing electronics comprises connecting the negative terminal of the first coil to the sensor output signal and the positive terminal of the first coil to a DC voltage.

In some embodiments, the plurality of connection mode circuits includes a third connection mode circuit. Connecting one of the plurality of connection mode circuits to the signal processing electronics comprises connecting the third connection mode circuit to the signal processing electronics in response to a third sensor mode signal that is indicative of a third type of sensor electronics and is distinct from the first and second sensor mode signals.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a schematic pictorial view of an example of a magnetostrictive displacement sensor, in accordance with embodiments of the present disclosure.

FIG. 2 is a simplified block diagram of an example of a magnetostrictive displacement sensor, in accordance with embodiments of the present disclosure.

FIG. 3 is a simplified diagram illustrating an example magnetostrictive displacement sensor that includes a coupling adapter, in accordance with embodiments of the present disclosure.

FIGS. 4-6 are simplified diagrams illustrating examples of different types of sensor electronics connected to examples of the magnetostrictive coupling adapter, in accordance with embodiments of the present disclosure.

FIG. 7 is a simplified diagram of an example of a magnetostrictive displacement sensor coupling adapter, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the specific embodiments set forth herein. Rather, embodiments are described so that this disclosure will be thorough and complete, and will fully convey the scope of the embodiments to those skilled in the relevant art.

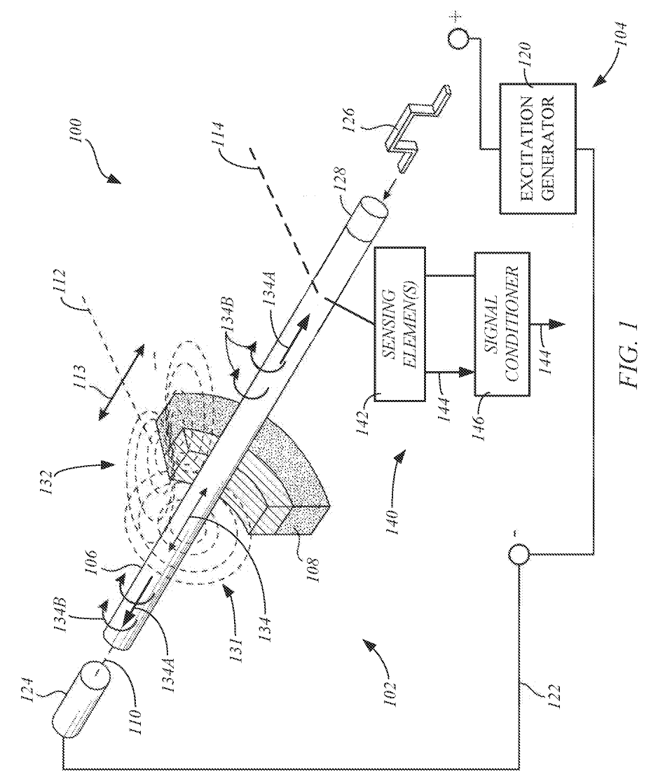

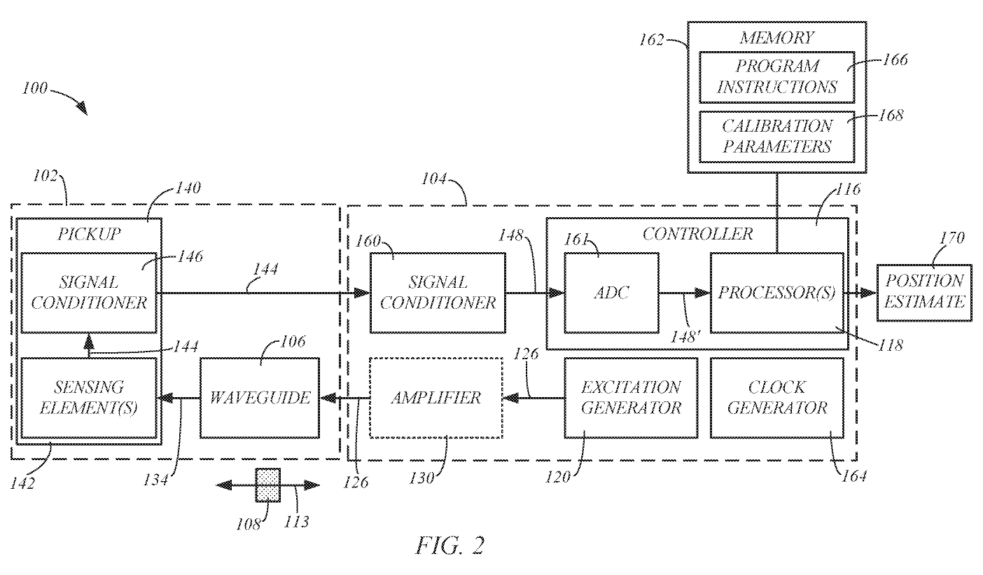

The general operation of an example of a magnetostrictive displacement sensor (MDS) 100 will be described with reference to FIGS. 1 and 2, which respectively are a schematic pictorial view and a simplified block diagram of the example MDS 100, in accordance with embodiments of the present disclosure. The MDS 100 includes sensor electronics 102 and signal processing electronics 104. The sensor electronics 102 includes a wire having magnetoelastic properties, referred to as a waveguide 106, and a target magnet 108 located near the waveguide 106. A position of the target magnet 108 is adjustable along an axis 110 of the waveguide 106, as indicated by arrow 113. The target magnet 108 may take the form of a bar magnet positioned alongside the waveguide 106, a ring magnet that surrounds the waveguide 106, or another suitable form. The MDS 100 is generally configured to measure or estimate the position 112 of the target magnet 108 along the waveguide 106 relative to a reference position 114.

The signal processing electronics 104 includes a controller 116 having one or more processors 118, and an excitation generator circuit 120 that is connected to the waveguide 106. For some types of sensor electronics 102, a closed electrical circuit may be formed by the excitation generator circuit 120, the waveguide 106, and a return wire 122 that connects a distal end 124 of the waveguide 106 back to the excitation generator circuit 120, as shown in FIG. 1. The controller 116 uses the excitation generator circuit 120 to generate an electrical current pulse 126 that is delivered to a proximal end 128 of the waveguide 106. An amplifier 130 (FIG. 2) of the signal processing electronics 104 may be used to amplify the current pulse 126 before applying it to the waveguide 106.

The transmission of the current pulse 126 through the waveguide 106 generates a magnetic field 131 that interacts with the magnetic field 132 of the magnet 108 to generate a mechanical magnetostrictive response (e.g., acoustic waves) 134 in the waveguide 106, which includes a longitudinal wave 134A (e.g., longitudinal compression) and a torsional wave 134B (e.g., torsional strain), as indicated in FIG. 1.

The magnetostrictive response 134 travels from both sides of the magnet 108 along the waveguide 106. For example, a portion of the magnetostrictive response 134 may travel along the waveguide 106 from the position 112 of the magnet 108 toward the end 124 and possibly to a damper (not shown) that reduces or eliminates propagation of the acoustic waves 134 back through the waveguide 106. A pickup 140 of the sensor electronics 104 is used to detect a portion of the magnetostrictive response 134 that travels from the position 112 of the magnet 108 toward the end 128, such as the longitudinal wave 134A and/or the torsional wave 134B.

The pickup 140 includes one or more conventional sensing elements 142 that are configured to generate an electrical sensor output signal 144 that includes a magnetostrictive response signal or indicator of the longitudinal wave 134A and/or an indicator of the torsional wave 134B. The one or more indicators may comprise a transient change or pulse in the magnitude of the signal 144, for example. The indicators may be detected by the controller 116 to determine the position 112 of the target magnet 108 based on the time from when the current pulse 126 is generated to when the indicator of the magnetostrictive response is detected in the signal 144 using conventional techniques.

A signal conditioner 146 of the pickup 140 may be used to isolate the sensing element 142 from electrical interference and condition (e.g., amplify, rectify, filter, etc.) the signal 144 before delivering it to the signal processing electronics 104, as indicated in FIG. 2. Thus, in some embodiments, the conditioned output signal 144 from the pickup 140 may be the original signal 144 generated by the sensing element(s) 142, such as when the pickup 140 does not include the signal conditioner 146, or the output signal 144 after being conditioned or processed by the circuitry of the signal conditioner 146.

The sensor electronics 104 may process the sensor output signal 144 using any suitable technique. The sensor electronics 104 may include a signal conditioner 160 instead of, or in addition to, the signal conditioner 146 of the pickup 140. As with the signal conditioner 146, the signal conditioner 160 includes circuitry that amplifies, rectifies, filters, compares and/or performs another conventional process on the signal 144, to form a processed sensor output signal 148. The signal 148 may be provided to an analog-to-digital converter (ADC) 161 of the controller 116 that converts signal 148 into corresponding digital samples 148' that may be processed by the one or more processors 118. The digital samples 148’ may be stored in non-transitory memory 162 of the MDS 100, such as a buffer or memory of the controller 116, for example.

The sensor electronics 104 may include a clock generator 164 that begins a timing routine when the current pulse 126 is generated by the excitation generator circuit 120. The clock generator 164 may be used to determine the time of each digital sample 148’ relative to the generation of the current pulse 126, in accordance with conventional techniques.

The one or more processors 118 of the controller 116 control components of the MDS 100 (e.g., excitation generator circuit 120), and/or perform one or more functions described herein in response to the execution of program instructions 166, calibration parameters 168, and/or other data stored in the memory 162. The memory 162 may represent memory of the sensor electronics 104, the sensor assembly 102 and/or memory of a measurement device (e.g., process level transmitter) that utilizes the MDS 100, and comprises any suitable non-transitory computer-readable media (e.g., flash memory, optical data storage, magnetic data storage, etc.).

Each processor 118 of the controller 116 may comprise one or more computer-based systems, control circuits, microprocessor-based engine control systems, and/or programmable hardware components (e.g., field programmable gate array), for example. While the controller 116 is shown as being a component of the sensor electronics 104, it is understood that the controller 116 may represent one or more controllers and processors that are used within a measurement device to perform one or more functions described herein.

In some embodiments, the at least one processor 118 is configured to analyze the digital samples 148' of the response signal 148 to detect the magnetostrictive response signal contained therein corresponding to the longitudinal wave 134A and/or the torsional wave 134B. The controller 116 may estimate or measure the position 112 of the target magnet 108 based on the detected magnetostrictive response signal(s) and the known speed of the waves through the waveguide 106, which may be indicated by the calibration parameters 168, in accordance with conventional techniques. The controller 116 may output a position estimate 170 that indicates the position 112.

As mentioned above, in some magnetostrictive position measurement systems, devices or sensors, the sensor electronics 102 may be detached from the signal processing electronics 104 to allow for the periodic replacement of the sensor electronics 102 and/or the signal processing electronics 104, and the coupling of the sensor electronics 102 to the signal processing electronics 104 through a cable, for example.

While this detachable feature provides many benefits, it can lead to problems. For example, due to the existence of different types of sensor electronics 102, a user may attempt to use a type of sensor electronics 102 that is not compatible with the signal processing electronics 104. This would prevent the signal processing electronics 104 from correctly processing the sensor output signal 144 resulting in invalid position estimates 170 and possible damage to components of the signal processing electronics 104.

Embodiments of the present disclosure include an MDS coupling adapter that facilitates the proper coupling of different types of sensor electronics 102 to signal processing electronics 104 by adapting the signal communications and/or connections between the sensor electronics 102 and the signal processing electronics 104 based on a detected type or characteristic of the sensor electronics 102 to form an operable MDS 100.

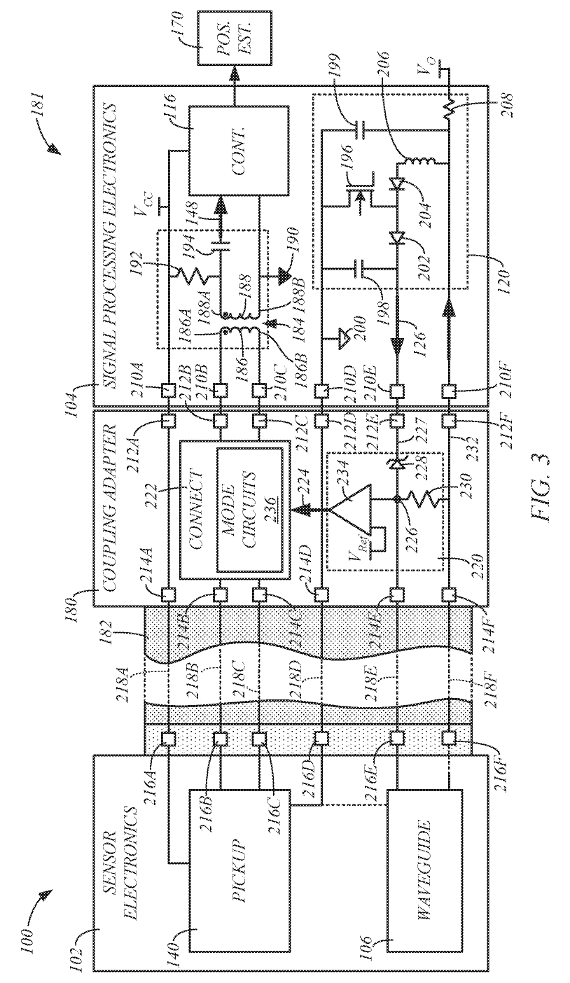

FIG. 3 is a simplified diagram illustrating an example MDS 100 that includes an MDS coupling adapter 180, in accordance with embodiments of the present disclosure. The coupling adapter 180 is generally positioned between the sensor electronics 102 and the signal processing electronics 104. The adapter 180 may be configured as a stand-alone device, or one that is integrated into the sensor electronics 102 or the signal processing electronics 104.

In one embodiment, a magnetostrictive displacement sensor assembly 181 is formed by the combination of the signal processing electronics 104 and the coupling adapter 180. The assembly may be used to form an MDS 100 through the attachment of the sensor electronics 102.

In some embodiments, the assembly 181 connects to the sensor electronics 104 through a cable 182, which may have a length of 1-100 meters, for example. The cable 182 allows the signal processing electronics 104 to be displaced from the sensor electronics 102. The cable 182 may be positioned between the adapter 180 and the sensor electronics 102 (as shown) or between the adapter 180 and the signal processing electronics 104. Alternatively, the adapter 180 may be used to directly connect the sensor electronics 102 to the signal processing electronics 104 without the cable 182.

Embodiments of the signal conditioner 160 of the processing electronics 104 include a transformer 184 having a primary coil 186 and a secondary coil 188 that provides galvanic isolation from the sensor electronics 102 and the cable 180 (if present). The sensor output signal 144 is received at the primary coil 186 and the processed sensor signal 148 is output to the controller 116 through the secondary coil 188, such as at a positive terminal 188A of the secondary coil relative to an electrical ground 190 (e.g., AGND), which is connected to a negative termina 188B of the secondary coil 188.

In some embodiments, a common voltage V_{CC} is connected to the positive terminal 188A of the secondary coil 188 through a resistor 192 and a capacitor 194. The capacitor 194 maintains a voltage relative to the electrical common voltage Vcc that corresponds to the voltage across the primary winding 186 (positive terminal 186A and negative terminal 186B), which represents the sensor output signal 144. The resistor 192 and the capacitor 194 may form a low-pass filter that isolates the frequencies relating to the magnetostrictive response signal or indicator in the sensor output signal 144.

The excitation generator 120 may take on any suitable form. FIG. 3 includes an example of a conventional excitation generator 120, which includes a suitable transistor 196 (e.g., MOSFET) and capacitors 198 and 199, which are connected to electrical ground 200. The excitation generator 120 may also include diodes 202 and 204, an inductor 206, and a resistor 208 and receive power from a DC offset voltage Vo, which may be about 18V for industrial sensors and about 5V for mobile sensors. When the transistor 196 is closed to conduct current from the supply voltage Vs to electrical ground 200, a current flows through the inductor 206 to electrical ground 200 and the excitation signal 126 is not generated. When the transistor 196 is opened, the current flowing through the inductor 206 is delivered to the waveguide 106 of the sensor electronics 102 as the excitation signal 126.

In some embodiments, the signal processing electronics 104 includes a plurality of conductors, contacts, pins or terminals (hereinafter “contacts”) 210, such as contacts 210A, 210B, 210C, 210D, 210E and/or 210F. In the illustrated example, the contact 210A may be connected to the common voltage Vcc, the contact 210B may be connected to a positive terminal of the primary coil, the contact 210C may be connected to a negative terminal of the primary coil, the contact 210D may be connected to electrical ground, the contact 210E may be connected to a positive terminal of the excitation generator 120 and the contact 210F may be connected to a negative terminal of the excitation generator 120.

The coupling adapter 180 may include contacts 212A-F that can be connected to the corresponding contacts 210A-F of the signal processing electronics 104 and contacts 214A-F that can be connected to corresponding contacts 216 of the sensor electronics 102, such as contacts 216A-F, for example, as shown in FIG. 3. The cable 182 may facilitate connections between the contacts 214A-F of the coupling adapter 180 and the contacts 216A-F of the sensor electronics 102 through corresponding conductors 218A-F.

Different types of sensor electronics 102 may utilize different numbers of the contacts 216, such as due to differences in circuitry of the sensor electronics 102. These differences may include, for example, differences in the manner in which the excitation signal 126 is received and applied to the waveguide 106, differences in the format of the sensor output signal 144, and/or other differences. While one type of the sensor electronics 102 may include six contacts 216A-F that generally correspond to the contacts 210A-F of the signal processing electronics 104, as shown in FIG. 3, other types of sensor electronics 102 may include four contacts 216 or five contacts 216, for example.

The coupling adapter 180 generally operates to adapt the connections and signal communications between two or more types of the sensor electronics 102 and the signal processing electronics 104 to form an operable MDS 100. The coupling adapter 180 generally includes a sensor detector 220 and a connection circuit 222.

The sensor detector 220 is configured to generate a sensor mode signal 224 that is indicative of the type of connected sensor electronics 102. In some embodiments, the sensor detector is configured to output at least two distinct sensor mode signals 224, such as three distinct sensor mode signals 224, each of which corresponds to a distinct type of conventional sensor electronics 102.

The connection circuit 222 is generally configured to adapt the sensor output signal 144 based on the sensor mode signal 224 such it can be properly processed by the signal processing electronics 104 to generate a valid position estimate 170 of the target magnet 108.

In some embodiments, the sensor detector 220 generates each of the plurality of distinct sensor mode signals 224 based on a mode voltage at a node 226 of a conductor 227 extending between the contacts 212E and 214E during a period when the excitation signal is not being generated. In one embodiment, the sensor detector 220 includes a diode 228 (e.g., Zener diode) that generally operates to decouple the DC offset voltage Vo from the waveguide 106 of the sensor electronics 102. In some embodiments, the sensor detector 220 includes a resistor 230 (e.g., about 10k ohms) extending between the conductor 227 and a conductor 232, which extends between the contacts 212F and 214F.

The mode voltage at the node 226 will depend on the type of the attached sensor electronics 102 defined by the circuitry of the attached sensor electronics 102, such as the circuitry connected to the waveguide 106. Accordingly, in one embodiment, the mode voltage is used to detect the type of sensor electronics being used. Examples of the distinct mode voltages corresponding to different types of attached sensor electronics 102 include about one half of the DC offset voltage Vo (e.g., about 9V or 2.5V), about the DC offset voltage Vo (e.g., about 18V or 5V), and a about 0 V.

In one embodiment, the sensor detector 220 includes a comparator 234 that compares the detected mode voltage V_{M} to a reference voltage V_{Ref} and outputs the sensor mode signal 224 based on a difference between the compared voltages. The reference voltage V_{Ref} is selected based on the DC offset voltage. For example, when the DC offset voltage Vo is about 18V, the reference voltage Vref may be set to about 9V, and when the DC offset voltage Vo is about 5V, the reference voltage Vref may be set to about 2.5V. It is understood that the comparator 234 may represent two or more comparators that are each used to detect a different type of the sensor electronics 102.

As discussed in greater detail below, the connection circuit selectively modifies the circuitry delivering the sensor output signal 144 to the signal processing electronics 104 using one of a plurality of connection mode circuits 236 based on the sensor mode signal 224. Each connection mode circuit 236 is configured to adapt the sensor output signal 144 for processing by the signal processing electronics 104 and facilitate the generation of a valid position estimate 170 for the target magnet 108.

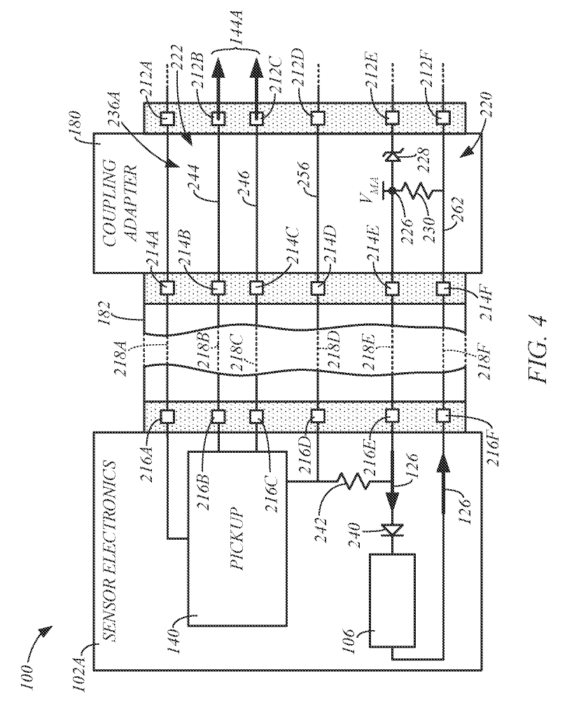

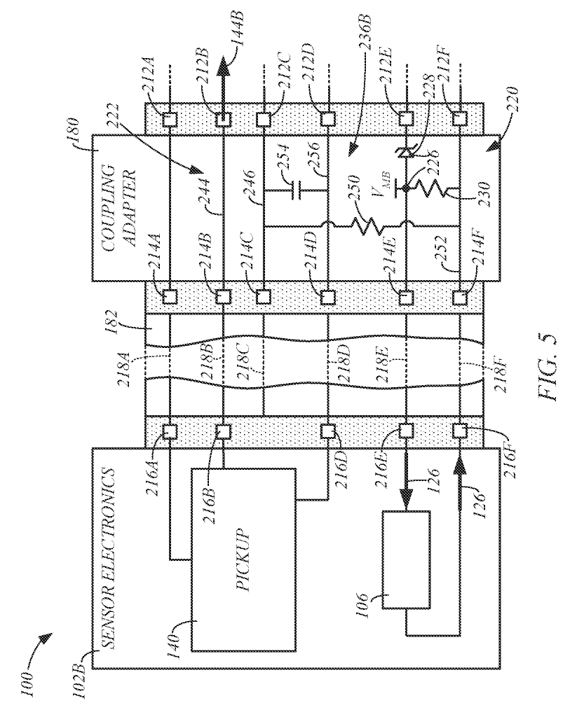

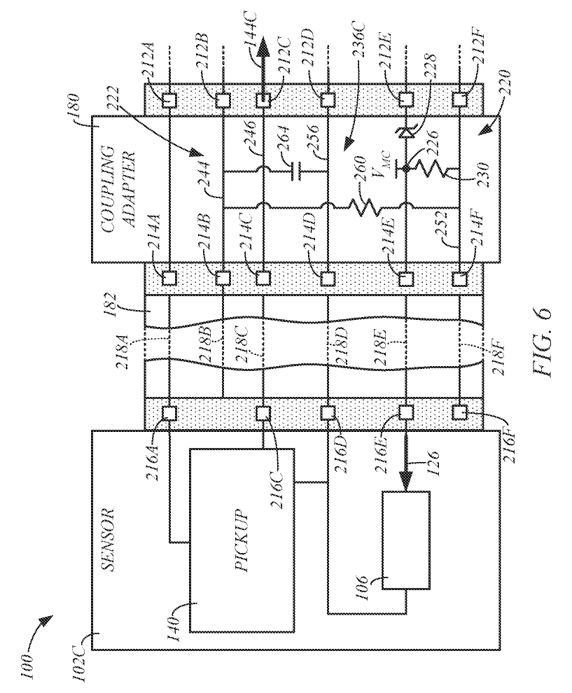

FIGS. 4-6 are simplified diagrams illustrating examples of different types of sensor electronics connected to the coupling adapter through the cable, including 6-contact sensor electronics 102A (FIG. 4), 5-contact sensor electronics 102B (FIG. 5) and 4-contact sensor electronics 102C (FIG. 6). The signal processing electronics 104 and some components of the sensor detector 220 are not shown to simplify the drawings. It is understood that, as mentioned above, while the coupling adapter 180 is illustrated as being connected to the sensor electronics 102 through the cable 182, the sensor electronics 102 may be directly connected to the coupling adapter 180 without the cable 182.

The conventional sensor electronics 102A shown in FIG. 4 includes six contacts 216A-F that generally connect to the six contacts 210A-F of the signal processing electronics 104 (FIG. 3), such as through the contacts 214A-F and 212A-F of the cable 182. Accordingly, the common voltage Vcc supplied at the signal processing electronics contact 210A may be connected to the sensor electronics contact 216A, the primary coil positive terminal 186A of the transformer 184 may be connected to the signal processing electronics contact 210B and the sensor electronics contact 216B through the connection mode circuit 236A, the primary coil negative terminal 286B of the transformer 184 may be connected to the signal processing electronics contact 210C and to the sensor electronics contact 216C through the connection mode circuit 236A, electrical ground 200 connected to signal processing electronics contact 210D may be coupled to the sensor electronics contact 216D, the positive terminal of the excitation generator 120 connected to the signal processing electronics contact 210E may be coupled to the sensor electronics contact 216E, such as through the diode 228, and the negative terminal of the excitation generator 120 connected to the signal processing electronics contact 210F may be coupled to the sensor electronics contact 216F.

In some embodiments, a positive terminal of the waveguide 106 of the sensor electronics 102A is connected to the contact 216E through a diode 240 and the return wire 122 is connected to the contact 216F. Accordingly, the excitation signal 126 may be delivered through the waveguide 106 and the return wire 122, as indicated in FIG. 4. The contact 216E may also be connected to electrical ground 200 (contact 216D) through a resistor 242 (e.g., about 10k ohm).

When the excitation signal 126 is not being generated, the diode 240 blocks the minus DC offset voltage Vo from reaching the contact 216E, which is connected to electrical ground 200 through the resistor 242. The mode voltage V_{MA} at the node 226 for the sensor electronics 102A depends upon the voltage divider formed by the resistor 230 (e.g., 10 kohm) of the voltage detector 220 and the resistor 242 of the sensor electronics 102A. In one example, the resistors 230 and 242 are set such that the mode voltage V_{MA} is approximately half of the DC offset voltage Vo, such as around 9V or 2.5V.

The sensor detector 220 produces the distinct sensor mode signal 224 (FIG. 3) based on the mode voltage V_{MA}, which drives the connection circuit 222 to connect the corresponding connection mode circuit 236A to the signal processing electronics. The connection mode circuit 236A establishes the connection between the sensor electronics contact 216B to the signal processing electronics contact 210B through a conductor 244 connecting the contact 214B to the contact 212B of the coupling adapter 180. The connection mode circuit 236A establishes the connection between the sensor electronics contact 216C to the signal processing electronics contact 210C through a conductor 246 connecting the contact 214C to the contact 212C of the coupling adapter 180.

In some embodiments, when the excitation signal 126 is generated, the pickup 140 of the sensor electronics 102A generates the sensor output signal 144A in the form of a differential voltage signal across the contacts 216B and 216C. The connection mode circuit 236A operates to communicate the differential sensor mode signal 144A to the terminals 186A and 186B of the primary coil 186 of the transformer 184 (FIG. 3). This allows the signal processing electronics 104 to generate a valid position estimate 170 based on the sensor output signal 144A.

The conventional sensor electronics 102B shown in FIG. 5 includes five contacts 216A, 216B and 216D-F that generally connect to the five contacts 210A, 210B and 210D-F of the signal processing electronics 104 (FIG. 3), such as through the contacts 214A, 214B and 214D-F and 212A, 212B and 212D-F of the cable 182. Accordingly, the common voltage Vcc supplied at the signal processing electronics contact 210A may be connected to the sensor electronics contact 216A, the primary coil positive terminal 186A of the transformer 184 may be connected to the signal processing electronics contact 210B and the sensor electronics contact 216B through the connection mode circuit 236B, the primary coil negative terminal 286B of the transformer 184 connected to the signal processing electronics contact 210C is not connected to a contact of the sensor electronics 102B, electrical ground 200 connected to signal processing electronics contact 210D may be coupled to the sensor electronics contact 216D, the positive terminal of the excitation generator 120 connected to the signal processing electronics contact 210E may be coupled to the sensor electronics contact 216E, such as through the diode 228, and the negative terminal of the excitation generator 120 connected to the signal processing electronics contact 210F may be coupled to the sensor electronics contact 216F.

When the excitation signal 126 is not being generated, the DC offset voltage Vo is connected to the node 226 through the return wire 122 and the waveguide 106. Since the impedance of the return wire 122 and the waveguide 106 are much less than the resistance of the resistor 230 of the sensor detector 220, the mode voltage V_{MB} for the sensor electronics 102B is generally that of the DC offset voltage Vo, such as around 18V or 5V.

The sensor detector 220 produces the distinct sensor mode signal 224 (FIG. 3) based on the mode voltage V_{MB}, which drives the connection circuit 222 to connect a corresponding connection mode circuit 236B to the signal processing electronics 104.

In one example, the connection mode circuit 236B includes the conductor 244 connecting the adapter contacts 214B and 212B, a resistor 250 (e.g., 8k ohms) that is connected in series between the conductor 246 connecting the contact 214C and 212C and a conductor 252 connecting the contacts 214F and 212F, and a capacitor 254 (e.g., 100 nF) that is connected in series between the conductor 246 a conductor 256 connecting the contacts 214D and 212D, which is connected to electrical ground 200.

When the excitation signal 126 is generated, the pickup 140 of the sensor electronics 102B discharges the sensor output signal 144B through the contact 216B relative to electrical ground 200. The connection mode circuit 236B operates to deliver the signal 144B to the primary coil positive terminal 186A of the transformer 184 (FIG. 3) through the conductor 244 and the signal processing electronics contact 210B, and maintains a DC voltage (e.g., 5V) at the primary coil negative terminal 186B using the capacitor 254. This allows the signal processing electronics 104 to properly process the sensor output signal 144B and produce a valid position estimate 170.

The conventional sensor electronics 102C shown in FIG. 6 includes four contacts 216A and 216C-E that generally connect to the four contacts 210A and 210C-E of the signal processing electronics (FIG. 3), such as through the contacts 214A and 214C-E and 212A and 212C-E of the cable 182. Accordingly, the common voltage Vcc supplied at the signal processing electronics contact 210A may be connected to the sensor electronics contact 216A, the primary coil positive terminal 186A of the transformer 184 connected to the signal processing electronics contact 210B is not connected to a sensor electronics contact, the primary coil negative terminal 286B of the transformer 184 connected to the signal processing electronics contact 210C is connected to the sensor electronics contact 216C through the connection mode circuit 236C, electrical ground 200 connected to signal processing electronics contact 210D may be coupled to the sensor electronics contact 216D, the positive terminal of the excitation generator 120 connected to the signal processing electronics contact 210E may be coupled to the sensor electronics contact 216E, such as through the diode 228, and the negative terminal of the excitation generator 120 connected to the signal processing electronics contact 210F is not connected to a sensor electronics contact.

In some embodiments, the conventional sensor electronics 102C connects the waveguide 106 to electrical ground 200 at contact 216D and does not include the return wire 122 of the sensor electronics 102A and 102B.

When the excitation signal is not being generated, the node 226 at which the mode voltage V_{MC} is detected is connected to the electrical ground 200 through the waveguide, which has a small resistance. As a result, the mode voltage V_{MC} for the sensor electronics 102C is generally about 0 V. The sensor detector 220 produces the distinct sensor signal 224 based on the mode voltage V_{MC}, which drives the connection circuit 222 to connect the corresponding connection mode circuit 236C to the signal processing electronics 104.

In one example, the connection mode circuit 236C includes the conductor 244 connecting the adapter contacts 214B and 212B, the conductor 246 connecting the adapter contacts 214C and 212C, a resistor 260 (e.g., 8k ohms) that is connected in series between the conductor 244 and the conductor 252 connecting the contacts 214F and 212F, and a capacitor 264 (e.g., 100 nF) that is connected in series between the conductor 244 and the conductor 256 connecting the contacts 214D and 212D, which is connected to electrical ground 200. As discussed below, the capacitors 254 and 264 may be the same capacitor.

When the excitation signal 126 is generated, the pickup 140 of the sensor electronics 102C discharges the sensor output signal 144C through the contact 216C relative to the electrical ground 200, and delivers the signal 144C to the primary coil negative terminal 186B of the transformer 184 (FIG. 3) through the contact 216C of the signal processing electronics 102C. The connection mode circuit 236C operates to deliver the signal 144C to the primary coil negative terminal 186B of the transformer 184 (FIG. 3) through the conductor 246 and the signal processing electronics contact 210C, and maintains a DC voltage (e.g., 5V) at the primary coil positive terminal 186A using the capacitor 264. This allows the signal processing electronics 104 to properly process the sensor output signal 144C and produce a valid position estimate 170.

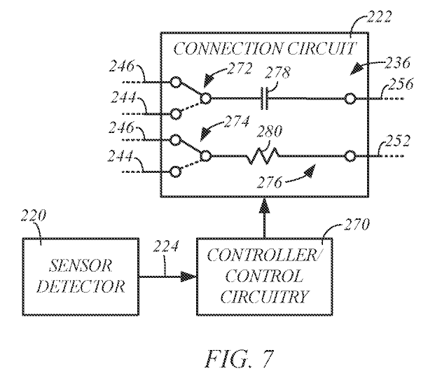

FIG. 7 is a simplified diagram of an example of the coupling adapter 180, in accordance with embodiments of the present disclosure. The adapter 180 includes a controller and/or control circuitry 270 that receives the sensor mode output signal 224 from the sensor detector 220 and controls the connection circuit 222 to connect one of the plurality of connection mode circuits 236 to the signal processing electronics 104 based on the sensor mode signal 224. The controller and/or control circuitry 270 may comprise the controller 116 of the sensor electronics 104, a separate controller and/or suitable circuitry for selectively using one of the connection mode circuits 236 based on the sensor mode signal 224.

The connection circuitry 222 may include circuitry that forms switches or switching elements 272, 274 and 276, that are used to selectively connect and/or disconnect circuit elements to form the connection mode circuit 236 corresponding to the sensor mode signal 224. For example, in one embodiment the connection circuitry 222 includes a single capacitor 278 that is used to fulfill the roles of the capacitor 254 (FIG. 5) and the capacitor 264 (FIG. 6), and the switch 272 may be used to selectively connect the cathode of the capacitor 278 to the conductor 246 to form a portion of the connection mode circuit 236B (FIG. 5) or to the conductor 244 to form a portion of the connection mode circuit 236C (FIG. 6). The switch 272 may also be used to disconnect the capacitor 278 from the conductors 244 and 246 to facilitate forming a portion of the connection mode circuit 236A (FIG. 4). Alternatively, the connection circuit 222 may comprise the capacitors 254 and 264 and separate switching elements for connecting the capacitors to the appropriate conductors in accordance with the sensor mode circuits 236B and 236C.

In some embodiments, the connection circuit 222 includes a resistor 280, which may serve as the resistor 250 of the connection mode circuit 236B (FIG. 5) and the resistor 260 of the connection mode circuit 236C (FIG. 6). The switches 274 and 276 may be used to connect the resistor 280 to the conductor 246 and the conductor 252 and form a portion of the connection mode circuit 236B, or connected the resistor 280 to the conductor 244 and the conductor 252 to form a portion of the connection mode circuit 236C. The switches 274 and 276 may also be used to disconnect the resistor 280 from the conductor 244, the conductor 246, and/or the conductor 252 to form a portion of the connection mode circuit 236A (FIG. 4). Alternatively, the connection circuit 222 may comprise the resistors 250 and 260 and separate switching elements for connecting the resistors to the appropriate conductors in accordance with the sensor mode circuits 236B and 236C.

As mentioned above, the connection mode circuit 236A (FIG. 4) may be formed by disconnecting the capacitor 278 from the conductor 244, the conductor 246 and/or the conductor 256, and by disconnecting the resistor 280 from the conductor 244, the conductor 246, and/or the conductor 252, such as using the switches 274 and 276.

Although the embodiments of the present disclosure have been described with reference to preferred embodiments, workers skilled in the art will recognize that changes may be made in form and detail without departing from the spirit and scope of the present disclosure.

Functions recited herein may be performed by a single controller or processor, multiple controllers or processors, or at least one controller or processor. As used herein, when one or more functions are described as being performed by a controller (e.g., a specific controller), one or more controllers, at least one controller, a processor (e.g., such as a specific processor), one or more processors or at least one processor, embodiments include the performance of the function(s) by a single controller or processor, or multiple controllers or processors, unless otherwise specified. Furthermore, as used herein, when multiple functions are performed by at least one controller or processor, all of the functions may be performed by a single controller or processor, or some functions may be performed by one controller or one processor, and other functions may be performed by another controller or processor. Thus, the performance of one or more functions by at least one controller or processor does not require that all of the functions are performed by each of the controllers or processors.

What is claimed is:

1. A magnetostrictive displacement sensor coupling adapter configured to facilitate communication of a sensor output signal from sensor electronics, which includes a waveguide and a target magnet that is moveable relative to the waveguide, to signal processing electronics configured to generate a position estimate of the target magnet relative to the waveguide based on a magnetostrictive response signal contained in the sensor output signal, the coupling adapter comprising:
a sensor detector configured to generate a sensor mode signal that is indicative of a type of connected sensor electronics; and
a connection circuit configured to selectively connect one of a plurality of connection mode circuits to connected signal processing electronics based on the sensor mode signal, each connection mode circuit configured to adapt the sensor output signal for processing by the signal processing electronics.

2. The magnetostrictive displacement sensor coupling adapter according to claim 1, wherein:
the plurality of connection mode circuits includes a first connection mode circuit and a second connection mode circuit; and
the sensor mode signal includes a first sensor mode signal that is indicative of a first type of sensor electronics, and a second sensor mode signal that is indicative of a second type of sensor electronics and is distinct from the first sensor mode signal,
wherein:
in response to the first sensor mode signal, the sensor output signal is adapted for processing by the signal processing electronics using the first connection mode circuit; and
in response to the second sensor mode signal, the sensor output signal is adapted for processing by the signal processing electronics using the second connection mode circuit.

3. The magnetostrictive displacement sensor coupling adapter according to claim 2, wherein:
the signal processing electronics includes a transformer having first and second coils;
the first connection mode circuit connects a positive terminal of the first coil to the sensor output signal and a negative terminal of the first coil to a DC voltage in response to the first sensor mode signal; and
the second connection mode circuit connects the negative terminal of the first coil to the sensor output signal and the positive terminal of the first coil to a DC voltage in response to the second sensor mode signal.

4. The magnetostrictive displacement sensor coupling adapter according to claim 3, wherein:
the first connection mode circuit comprises a capacitor connected between the negative terminal of the first coil and electrical ground; and
the second connection mode circuit comprises a capacitor connected between the positive terminal of the first coil and electrical ground.

5. The magnetostrictive displacement sensor coupling adapter according to claim 2, wherein:
the plurality of connection mode circuits includes a third connection mode circuit;
the sensor mode signal includes a third sensor mode signal that is indicative of a third type of sensor electronics and is distinct from the first and second sensor mode signals; and
in response to the third sensor mode signal, the sensor output signal is adapted for processing by the signal processing electronics using the third connection mode circuit.

6. The magnetostrictive displacement sensor coupling adapter according to claim 5, wherein:
the signal processing electronics includes a transformer having first and second coils;
the first connection mode circuit connects a positive terminal of the first coil to the sensor output signal and a negative terminal of the first coil to a DC voltage in response to the first sensor mode signal;
the second connection mode circuit connects the negative terminal of the first coil to the sensor output signal and the positive terminal of the first coil to a DC voltage in response to the second sensor mode signal; and
the third connection mode circuit connects the positive and negative terminals of the first coil to the sensor output signal in response to the third sensor mode signal.

7. The magnetostrictive displacement sensor coupling adapter according to claim 1, wherein the first and second sensor mode signals are based on a voltage of a conductor connected to a waveguide of the sensor electronics or a conductor connected to an excitation generator of the signal processing electronics.

8. A magnetostrictive displacement sensor assembly comprising:
signal processing electronics configured to generate a position estimate of a target magnet relative to a waveguide of sensor electronics based on a sensor output signal from a pickup of the sensor electronics; and
a coupling adapter comprising:
a sensor detector configured to generate a sensor mode signal that is indicative of a type of the sensor electronics; and
a connection circuit configured to selectively connect one of a plurality of connection mode circuits to the signal processing electronics based on the sensor mode signal, each connection mode circuit configured to adapt the sensor output signal for processing by the signal processing electronics.

9. A magnetostrictive displacement sensor comprising:
the magnetostrictive displacement sensor assembly according to claim 8;
the target magnet; and
the sensor electronics connected to the coupling adapter, the sensor electronics including the waveguide and the pickup, wherein the pickup is configured to generate the sensor output signal in response to a magnetostrictive response in the waveguide corresponding to the target magnet.

10. The magnetostrictive displacement sensor according to claim 9, including a cable connecting the coupling adapter to the sensor electronics.

11. The magnetostrictive displacement sensor assembly according to claim 8, wherein:
the plurality of connection mode circuits includes a first connection mode circuit and a second connection mode circuit; and
the sensor mode signal includes a first sensor mode signal that is indicative of a first type of sensor electronics, and a second sensor mode signal that is indicative of a second type of sensor electronics and is distinct from the first sensor mode signal,
wherein:
in response to the first sensor mode signal, the sensor output signal is adapted for processing by the signal processing electronics using the first connection mode circuit; and
in response to the second sensor mode signal, the sensor output signal is adapted for processing by the signal processing electronics using the second connection mode circuit.

12. The magnetostrictive displacement sensor assembly according to claim 11, wherein:
the signal processing electronics includes a transformer having first and second coils;
the first connection mode circuit connects a positive terminal of the first coil to the sensor output signal and a negative terminal of the first coil to a DC voltage in response to the first sensor mode signal; and
the second connection mode circuit connects the negative terminal of the first coil to the sensor output signal and the positive terminal of the first coil to a DC voltage in response to the second sensor mode signal.

13. The magnetostrictive displacement sensor assembly according to claim 12, wherein:
the first connection mode circuit comprises a capacitor connected between the negative terminal of the first coil and electrical ground; and
the second connection mode circuit comprises a capacitor connected between the positive terminal of the first coil and electrical ground.

14. The magnetostrictive displacement sensor assembly according to claim 12, wherein:
the plurality of connection mode circuits includes a third connection mode circuit;
the sensor mode signal includes a third sensor mode signal that is indicative of a third type of sensor electronics and is distinct from the first and second sensor mode signals; and
in response to the third sensor mode signal, the sensor output signal is adapted for processing by the signal processing electronics using the third connection mode circuit.

15. The magnetostrictive displacement sensor assembly according to claim 14, wherein:
the signal processing electronics includes a transformer having first and second coils;
the first connection mode circuit connects a positive terminal of the first coil to the sensor output signal and a negative terminal of the first coil to a DC voltage in response to the first sensor mode signal;
the second connection mode circuit connects the negative terminal of the first coil to the sensor output signal and the positive terminal of the first coil to a DC voltage in response to the second sensor mode signal; and
the third connection mode circuit connects the positive and negative terminals of the first coil to the sensor output signal in response to the third sensor mode signal.

16. The magnetostrictive displacement sensor assembly according to claim 8, wherein the first and second sensor mode signals are based on a voltage of a conductor connected to the waveguide of the sensor electronics.

17. A method of communicating a sensor output signal from sensor electronics, which includes a waveguide and a target magnet that is moveable relative to the waveguide, to signal processing electronics configured to generate a position estimate of the target magnet relative to the waveguide based on a magnetostrictive response signal contained in the sensor output signal, the method comprising:
providing a coupling adapter between the sensor electronics and the signal processing electronics, the coupling adapter comprising a plurality of connection mode circuits, each configured to adapt the sensor output signal for processing by the signal processing electronics;
connecting one of the plurality of connection mode circuits to the signal processing electronics based on a sensor mode signal that is indicative of a type of the sensor electronics; and
communicating the sensor output to the signal processing electronics using the connection mode circuit that is connected to the signal processing electronics.

18. The method according to claim 17, wherein:
the plurality of connection mode circuits includes a first connection mode circuit and a second connection mode circuit; and
connecting one of the plurality of connection mode circuits to the signal processing electronics comprises:
connecting the first connection mode circuit to the signal processing electronics in response to a first sensor mode signal that is indicative of a first type of sensor electronics; and
connecting the second connection mode circuit to the signal processing electronics in response to a second sensor mode signal that is indicative of a second type of sensor electronics and is distinct from the first sensor mode signal.

19. The method according to claim 18, wherein:
the signal processing electronics includes a transformer having first and second coils;
connecting the first connection mode circuit to the signal processing electronics comprises connecting a positive terminal of the first coil to the sensor output signal and a negative terminal of the first coil to a DC voltage; and
connecting the second connection mode circuit to the signal processing electronics comprises connecting the negative terminal of the first coil to the sensor output signal and the positive terminal of the first coil to a DC voltage.

20. The method according to claim 19, wherein:
the plurality of connection mode circuits includes a third connection mode circuit; and
connecting one of the plurality of connection mode circuits to the signal processing electronics comprises connecting the third connection mode circuit to the signal processing electronics in response to a third sensor mode signal that is indicative of a third type of sensor electronics and is distinct from the first and second sensor mode signals.
